(19) United States
(12) Patent Application Publication
(10) Pub. No.: US 2014/0292187 A1
(43) Pub. Date: Oct. 2, 2014

(54) Heater Lamp and Heating Module

(71) Applicant: Toshiba Lighting & Technology Corporation, Yokosuka-shi (JP)

(72) Inventors: Masaaki Takatsuka, Yokosuka-shi (JP); Yoshitaka Fujita, Yokosuka-shi (JP); Tsuyoshi Ohashi, Yokosuka-shi (JP)

(73) Assignee: Toshiba Lighting & Technology Corporation, Yokosuka-shi (JP)

(21) Appl. No.: 14/032,356

(22) Filed: Sep. 20, 2013

(30) Foreign Application Priority Data
Mar. 29, 2013 (JP) 2013-074935

(51) Int. Cl. H01K 1/14

(52) U.S. Cl. CPC H01K 1/14
USPC 313/578

(57) ABSTRACT

According to embodiments, a heater lamp that includes a bulb and an anchor ring is provided. The bulb has a linear portion and at least one bent portion. The bulb has a filament therein that includes a plurality of first coils which are connected in series, and a second coil which is connected to the first coils in series and has a number of turns less than that of the first coils. The bulb is sealed at both ends and light transmissive. The anchor ring holds the filament inside the bulb.

### CROSS-REFERENCE TO RELATED APPLICATIONS

This application is based upon and claims the benefit of priority from the Japanese Patent Application No. 2013-074935, filed on Mar. 29, 2013; the entire contents of which are incorporated herein by reference.

### FIELD

Embodiments described herein relate generally to a heater lamp and a heating module.

### BACKGROUND

For example, in molding a resin container and the like, a heater lamp that heats the resin container is employed. The heater lamp is desired to have a long lasting lifetime.

### BRIEF DESCRIPTION OF THE DRAWINGS

FIG. 1 is a schematic view illustrating a heater lamp according to a first embodiment;

FIG. 2 is a schematic view illustrating another heater lamp according to the first embodiment;

FIGS. 3A to 3D are schematic views illustrating still another heater lamp according to the first embodiment;

FIGS. 4A and 4B are schematic views illustrating yet another heater lamp according to the first embodiment; and

FIG. 5 is a schematic view illustrating a heating module according to a second embodiment.

### DETAILED DESCRIPTION

According to embodiments, a heater lamp that includes a bulb and an anchor ring is provided. The bulb has a linear portion and at least one bent portion. The bulb has a filament therein that includes a plurality of first coils which are connected in series, and a second coil which is connected to the first coils in series and has a number of turns less than that of the first coils. The bulb is sealed at both ends and light transmissive. The anchor ring holds the filament inside the bulb.

Hereinafter, each embodiment will be described referring to views.

The views are schematic and conceptual such that a relation between the thickness and the width of each portion, and a ratio of sizes between portions are not necessarily the same as realized elements. When showing the same portions, measurements or ratios may be differently shown from each other depending on views.

In the specification and each view, the same reference numeral is applied to an element that is similar to an aforementioned element in a previous view, and a detailed description is appropriately omitted.

### First Embodiment

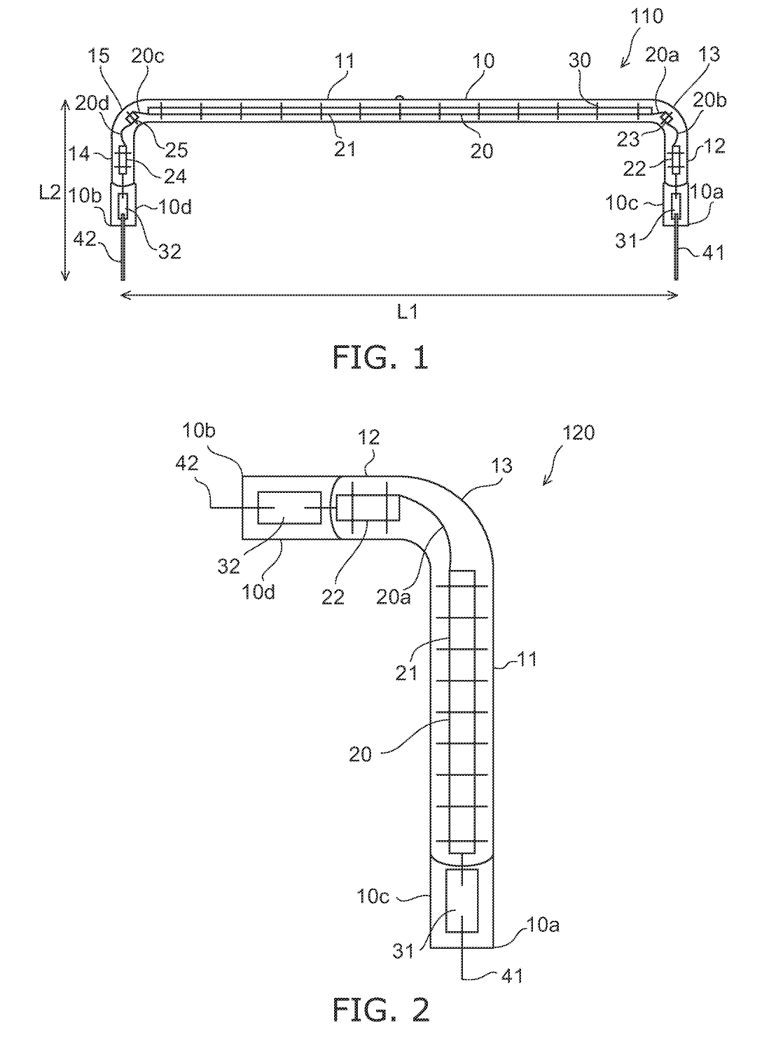

FIG. 1 is a schematic view illustrating the heater lamp according to a first embodiment.

As shown in FIG. 1, a heater lamp 110 according to the embodiment has a bent shape. The heater lamp 110 according to the embodiment includes a bulb 10, a filament 20, and an anchor ring 30. The bulb 10 is light transmissive.

The bulb 10 has a bent portion. That is, the bulb 10 includes a first light-emitting portion 11, a second light-emitting portion 12 provided to extend in a direction different from an extending direction of the first light-emitting portion 11, and a bent portion 13 provided between the first light-emitting portion 11 and the second light-emitting portion 12. In the example, the second light-emitting portion 12 is substantially perpendicular to the first light-emitting portion 11. In the embodiment, the angle between the first light-emitting portion 11 and the second light-emitting portion 12 is arbitrary. In other words, the first light-emitting portion 11 and the second light-emitting portion 12 are linear portions. The bent portion 13 which is provided between the first light-emitting portion 11 and the second light-emitting portion 12 forms one bent portion.

In the example, another linear portion and another bent portion are further provided. That is, the bulb 10 further includes a second light-emitting portion 14 provided to extend in a direction different from the extending direction of the first light-emitting portion 11, and a bent portion 15 provided between the first light-emitting portion 11 and the second light-emitting portion 14. The second light-emitting portion 14 is substantially perpendicular to the first light-emitting portion 11. In the embodiment, the angle between the first light-emitting portion 11 and the second light-emitting portion 14 is arbitrary. In other words, the second light-emitting portion 14 is another linear portion. The bent portion 15 provided between the first light-emitting portion 11 and the second light-emitting portion 14 is another bent portion.

In the example, the second light-emitting portion 14 is parallel with the second light-emitting portion 12. In the embodiment, mutual positional relation between the second light-emitting portion 12 and the second light-emitting portion 14 is arbitrary.

The filament 20 is provided inside the bulb 10. The filament 20 includes the plurality of first coils which are connected in series, and the second coil which is connected to the first coils in series and has a number of turns less than that of the first coils. The aforementioned term “connected in series” is not limited to a configuration in which, for example, the first coil and the second coil are in separate bodies such that, for example, the first coil and the second coil are connected to each other in series using a caulking member. The term also includes a configuration in which, for example, the first coil and the second coil are integrally formed by the same lead wire. The filament 20 includes a first section 21 located inside the first light-emitting portion 11, and a second section 22 located inside the second light-emitting portion 12. As described below, the first section 21 and the second section 22 correspond to the first coil.

The filament 20 includes a third section 23 located inside the bent portion 13, an intermediate portion 20a provided between the first section 21 and the third section 23, and an intermediate portion 20b provided between the second section 22 and the third section 23. As described below, the third section 23 and the intermediate portions 20a and 20b correspond to, as described below, the second coil. In other words, the first coils are provided at both sides of the second coil.

In the example, the filament 20 further includes a fourth section 24 located inside the second light-emitting portion 14. As described below, the fourth section 24 corresponds to the first coil.

The filament 20 further includes a fifth section 25 located inside the bent portion 15, an intermediate portion 20c provided between the first section 21 and the fifth section 25, and an intermediate portion 20d provided between the fourth section 24 and the fifth section 25. As described below, the fifth section 25 and the intermediate portions 20c and 20d correspond to the second coil. In other words, the first coils are provided at both sides of the second coil.

One end of the second section 22 is connected to one end of the third section 23. Another end of the third section 23 is connected to one end of the first section 21. Another end of the first section 21 is connected to one end of the fifth section 25. Another end of the fifth section 25 is connected to one end of the fourth section 24.

The bulb 10 has a first end portion 10a at the second light-emitting portion 12 side, and a second end portion 10b at the second light-emitting portion 14 side. A first sealing portion 10c is provided in the first end portion 10a. A second sealing portion 10d is provided in the second end portion 10b. Inside the first sealing portion 10c, a first conductive portion 31 is provided. One end of the first conductive portion 31 is located at an internal side of the bulb 10. The other end of the first conductive portion 31 is located at an external side of the bulb 10. Inside the second sealing portion 10d, a second conductive portion 32 is provided. One end of the second conductive portion 32 is located at the internal side of the bulb 10. The other end of the second conductive portion 32 is located at the external side of the bulb 10.

The other end of the second section 22 is connected to one end of the first conductive portion 31. The other end of the first conductive portion 31 is connected to an outer lead 41. The other end of the fourth section 24 is connected to one end of the second conductive portion 32. The other end of the second conductive portion 32 is connected to an outer lead 42.

For example, quartz glass is employed for example, for the bulb 10. A cross-section into which the bulb 10 is cut in a plane perpendicular to the extending direction of the bulb 10 is, for example, a circular shape.

Tungsten is employed for the filament 20. The filament 20 is, for example, a filament coil. The filament 20 is sealed inside the bulb 10. Inside the bulb 10, for example, the anchor ring 30 which holds the filament 20 is provided.

For example, inert gas (for example, at least any one of Ar, Kr and Xe) is encapsulated inside the bulb 10. Nitrogen and bromine may be further encapsulated inside the bulb 10. Both ends of the bulb 10 (quartz glass tube) are sealed, and the inside of the bulb 10 is hermetic. The gas encapsulated inside the bulb 10 includes, for example, Kr, N₂ and CH₂Br₂. In other words, halogen is encapsulated inside the bulb 10. The volume ratio of Kr with respect to the entire gas is, for example, approximately 95%. The volume ratio of N₂ with respect to the entire gas is, for example, approximately 5%. The volume ratio of CH₂Br₂ with respect to the entire gas is, for example, approximately 0.17%.

For example, Mo foil is laid in the first sealing portion 10c and the second sealing portion 10d of the bulb 10 as a conductive portion. The filament 20 is connected to the internal side of the bulb 10 with the Mo foil. The outer leads 41 and 42 are connected to the external side of the bulb 10 with the Mo foil. For example, Mo bar is employed for the outer leads 41 and 42.

In the example, a length L1 which is the length between the outer lead 41 and the outer lead 42, and which is parallel to the first light-emitting portion 11 is, for example, 250 mm. A length L2 along the second light-emitting portions 12 and 14 of the heater lamp 110 is, for example, 72 mm. For example, the total length of the filament 20 is 260 mm.

A lighting condition for the heater lamp 110 is, for example, AC 400 V and 3500 W (rated voltage).

In the embodiment, the first light-emitting portion 11 forms a light-emitting portion for heating. The second light-emitting portion 12 (and the second light-emitting portion 14) is a short auxiliary light-emitting portion for halogen cycle. The bent portion 13 (and the bent portion 15) is a temperature lowering portions.

For example, when electric current flows through the filament 20, the temperature of the bent portion 13 is lower than the temperature of the first light-emitting portion 11 and the second light-emitting portion 12.

For example, when electric current flows through the filament 20, the first coils (the first section 21 and the second section 22) are under high temperature. When electric current flows through the filament 20, the second coil (the third section 23, and the intermediate portions 20a and 20b) is under lower temperature than that of the aforementioned high-temperature portion.

For example, when electric current flows through the filament 20, the intensity of light emitted from the second section 22 is lower than the intensity of light emitted from the first section 21. Then, the intensity of light emitted from the third section 23 is lower than the intensity of light emitted from the second section 22.

Similarly, when electric current flows through the filament 20, the temperature of the bent portion 15 is lower than the temperature of the first light-emitting portion 11 and the second light-emitting portion 14.

Similarly, for example, when electric current flows through the filament 20, the high-temperature portion (the fourth section 24) is under high temperature. When electric current flows through the filament 20, low-temperature portions (the fifth section 25, and the intermediate portion 20c and 20d) are under lower temperature than that of the high-temperature portion thereof.

Similarly, for example, when electric current flows through the filament 20, the intensity of light emitted from the fourth section 24 is lower than the intensity of light emitted from the first section 21. Then, the intensity of light emitted from the fifth section 25 is lower than the intensity of light emitted from the fourth section 24.

Accordingly, a heater lamp with a long lasting lifetime can be provided.

For example, when a bent portion is provided in a bulb as described above, for example, in manufacturing, the bent portion is formed by bending a bar-shaped bulb. At this moment, distortion is easily generated in the bent portion. The heater lamp is a high-load heater through which large electric current flows. In the bulb having the bent portion, a glass-crack is found to be easily generated in the bent portion due to heating by the filament coil. The glass-crack can be considered to be caused by distortion generated during manufacturing. The lifetime of the heater lamp becomes short due to the glass-crack.

The embodiment focuses on the above-described phenomenon. In the embodiment, the light (heat) generated in the bent portion (for example, the bent portion 13) is caused to be weaker than the light (heat) generated elsewhere other than the bent portion (for example, the first light-emitting portion 11). For example, the bent portion is a non-light emitting portion (a portion relatively weak in emitting light). Accordingly, heat radiation is improved, and load of the bent portion is reduced. Accordingly, the glass-crack in the bent portion with great distortion can be suppressed, thereby allowing the long lasting lifetime.

The second light-emitting portions 12 and 14 corresponding to an end portion of the heater generate the light (heat) weaker than that of the first light-emitting portion 11 which is a light-emitting portion for heating. Accordingly, the halogen cycle can be smoothly carried out. The second light-emitting portion 12 (and the second light-emitting portion 14) is, for example, the auxiliary light-emitting portion. Particularly, halogen encapsulated in the bulb 10 is easily condensed at both ends of the bulb, where the temperature is relatively lower inside the heater lamp. Therefore, the second light-emitting portions 12 and 14 are desirable to be provided in at least any one of the both ends of the bulb 10.

The third section 23 located inside the bent portion 13 is, for example, a coil with a number of turns less than that of the first section 21 and the second section 22. The third section 23 is a Filament Between Segment (FBS: non-coil portion). Accordingly, the light (heat) generated in the third section 23 can be reduced more than other portions. The filament 20 is desirably accommodated in the approximate center of the bent portion 13 when viewed in a cross section which is perpendicular to the extending direction of the bulb 10. Specifically, the third section is also desired to have the anchor ring 30. The filament 20 accommodated in the bent portion 13 may be the FBS. However, the third section 23 is desirably a coil shorter than that of the first section 21 and the second section 22, in order to provide the anchor ring 30 therein.

The total number of turns of the second coil (the third section 23, and the intermediate portions 20a and 20b) is desirably ten or less. If the number of turns of the third section 23, and the intermediate portion 20a and 20b is more than ten turns in total, a light-emitting amount, that is, an amount of heat generation from the third section 23, and the intermediate portions 20a and 20b increases so as to generate distortion in the bent portion, thereby being unfavorable. Similarly, the total number of turns of the second coil (the fifth section 25, and the intermediate portions 20c and 20d) is desirably ten or less.

The number of turns of the second sections 22 and 24 which are employed in the second light-emitting portions 12 and 14, is less than the number of turns of the first section 21 which is employed in the first light-emitting portion 11, and is more than the number of turns of the second coil (the third section 23, and the intermediate portions 20a and 20b; or the fifth section 25, and the intermediate portions 20c and 20d).

According to the embodiment, a heater lamp with a long lasting lifetime can be provided.

Hereinafter, examples of characteristics of the heater lamp according to the embodiment will be described together with characteristics of reference examples.

In a first reference example, uniform filaments are provided throughout the entire bulb. That is, the filament in its entirety is the first coil, and the second coil is not provided. The configuration other than the aforementioned matter is similar as the configuration of the heater lamp 110 according to the embodiment.

In a second reference example, in the filament 20, only the first section 21 inside the first light-emitting portion 11 is provided as the first coil, and no other first coil is provided. That is, the second coil is provided inside the second light-emitting portion 12, the bent portion 13, the second light-emitting portion 14, and the bent portion 15. The configuration other than the aforementioned matter is similar as the configuration of the heater lamp 110 according to the embodiment.

The above-mentioned heater lamps will be described regarding examples of test results in continuous lighting. In the test, ten samples are respectively tested for the heater lamp 110 according to the embodiment, the heater lamp of the first reference example, and the heater lamp of the second reference example. The test results are as follows.

In the second reference example, a failure (lighting failure) occurs in all of the ten samples when continuously lighted for 100 hours. In the initial lighting stage of the second reference example, the filament 20 in the vicinity of the sealing portion is worn due to collision of the halogen, thereby causing an early disconnection of the filament 20. Therefore, the aforementioned failure occurs.

In the first reference example, the failure does not occur when continuously lighted for 5,000 hours. However, the failure (breakage of lamp) occurs in five samples out of ten samples when continuously lighted for 8,000 hours. In the first reference example, distortion remaining in the bent portion becomes significant, thereby leading to the breakage of lamp.

In contrast, in the heater lamp 110 according to the embodiment, the failure does not occur in ten samples even when continuously lighted for 8,000 hours or more. According to the embodiment, the breakage of lamp does not occur, even if continuously lighted for a long period.

In the embodiment, a shape of the bulb 10 is arbitrary. The number of the bent portion is also arbitrary.

In the embodiment, the second sections 22 and 24 provided in the second light-emitting portions 12 and 14 generate the light (little heat) weaker than that of the first section 21 provided in the first light-emitting portion 11. The aforementioned second section 22 may be provided close to the bent portions 13 and 15 of the bulb 10, and may be provided close to the end portion of the bulb 10.

The heater lamp according to the embodiment is, for example, employed in molding of a resin container (for example, PET bottle and the like). An irradiated body which is heated by the heater lamp according to the embodiment is arbitrary.

FIG. 2 is a schematic view illustrating another heater lamp according to the first embodiment.

A heater lamp 120 illustrated in FIG. 2 is in a shape having a right-angled bent section.

As shown in FIG. 2, in the heater lamp 120 according to the embodiment, the second light-emitting portion 14, the bent portion 15, the fourth section 24, and the fifth section 25 of the above-mentioned heater lamp 110 are not provided. The configuration other than the aforementioned matter can be made similar as that of the heater lamp 110, thereby omitting the description.

When the heater lamp 120 has the configuration of the above-described shape, the intensity of light emitted from the first light-emitting portion 11 can be strengthened such that the first light-emitting portion 11 side can be heated. Particularly, when the heater lamp 120 is in a shape having the right-angled bent section, and only the second light-emitting portion 12 is fixed thereto, even though the first light-emitting portion 11 expands or shrinks in the extending direction of the first light-emitting portion 11 due to the atmosphere around the heater lamp 120, distortion is less likely to occur in the bent portion 13. Therefore, the lamp can be further prevented from the breaking.

According to the heater lamp 120 as well, a heater lamp with a long lasting lifetime can be provided.

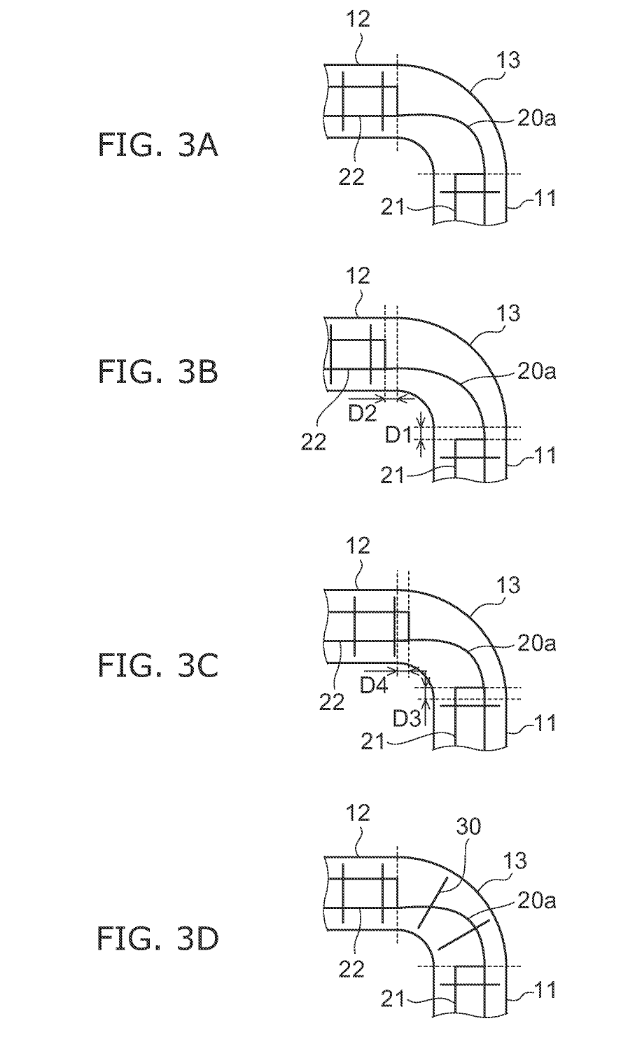

FIGS. 3A to 3D are schematic views illustrating still another heater lamp according to the first embodiment.

As shown in FIG. 3A, in the example, the position of the end portion of the first section 21 is substantially the same as the position of the end portion of the first light-emitting portion 11. The position of the end portion of the second section 22 is substantially the same as the position of the end portion of the second light-emitting portion 12. The intermediate portion 20a is provided as the FBS. Likewise, the end portion of the light-emitting portion (first coil) of the filament 20 is preferably arranged at a boundary section between the linear section (first light-emitting portion or second light-emitting portion) and the bent portion 13 of the bulb 10. Only the intermediate portion 20a may be configured in the bent portion 13 as the low-temperature portion of the filament 20 in place of the third section 23.

As shown in FIG. 3B, in the example, the position of the end portion of the first section 21 is arranged away from the bent portion 13 and close to the first light-emitting portion 11 side. The position of the end portion of the second section 22 is arranged away from the bent portion 13 and close to the second light-emitting portion 12 side. That is, the end portion of the light-emitting portion (first coil) of the filament 20 may be arranged inside the linear section of the bulb 10. In this case, for example, even though an attachment error or a dimension error occurs, the intermediate portion 20a (second coil) can be reliably provided in the bent portion 13. However, a distance D1 between the end portion of the first section 21 and the end portion of the first light-emitting portion 11, and a distance D2 between the end portion of the second section 22 and the end portion of the second light-emitting portion 12 are desirably within 3 mm.

As shown in FIG. 3C, in the example, the position of the end portion of the first section 21 is arranged away from the first light-emitting portion 11 and close to the bent portion 13 side. The position of the end portion of the second section 22 is arranged away from the second light-emitting portion 12 and close to the bent portion 13 side. That is, the end portion of the light-emitting portion (first coil) of the filament 20 may be arranged inside the bent portion 13. In this case, lighting quantity of the light emitting from the bent portion 13 can be increased. However, a distance D3 between the end portion of the first section 21 and the end portion of the first light-emitting portion 11, and a distance D4 between the end portion of the second section 22 and the end portion of the second light-emitting portion 12 are desirably within 3 mm.

As shown in FIG. 3D, in the example, the anchor ring 30 is provided in the bent portion 13. Likewise, the anchor ring 30 may be provided in the intermediate portion 20a.

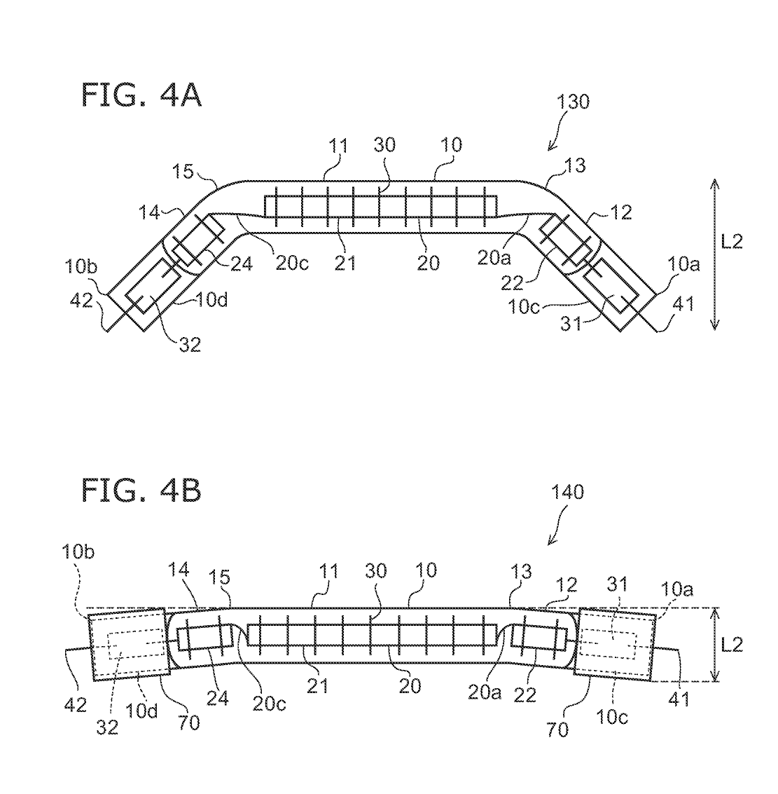

FIGS. 4A and 4B are schematic views illustrating yet another heater lamp according to the first embodiment. A heater lamp 130 illustrated in FIG. 4A has a shape with a small bent angle. A heater lamp 140 illustrated in FIG. 4B has bases 70 in the first sealing portion 10c and the second sealing portion 10d, and has a shape with a small bent angle.

As shown in FIG. 4A, in yet another heater lamp 130 according to the embodiment, the configuration other than the difference in shape can be made similar as that of the heater lamp 110, thereby omitting the description.

In the heater lamp 130 compared to the heater lamp 110, the length L2 which is perpendicular to the extending direction of the first light-emitting portion 11 can be shortened. When the L2 is shortened, for example, the height of an apparatus to which the heater lamp is attached can be lowered. As a result, the apparatus can be reduced in size.

As shown in FIG. 4B, in yet another heater lamp 140 according to the embodiment, the configuration other than having the bases 70 at the first sealing portion 10c and the second sealing portion 10d can be made similar as that of the heater lamp 130, thereby omitting the description.

In the heater lamp 140, even though the bulb 10 is in a shape having the bases 70, when the bulb 10 is in a shape with small bent angle under consideration of an outer diameter measure of the bases 70, the L2 can be reduced to be as small as possible. When the L2 is reduced, for example, the height of an apparatus to which the heater lamp is attached can be lowered. As a result, the apparatus can be reduced in size.

### Second Embodiment

The present embodiment regards a heating module. The heating module includes any one of the heater lamps described according to the first embodiment, or modified heater lamps thereof. In the following example, a description employing the heater lamp 110 will be given.

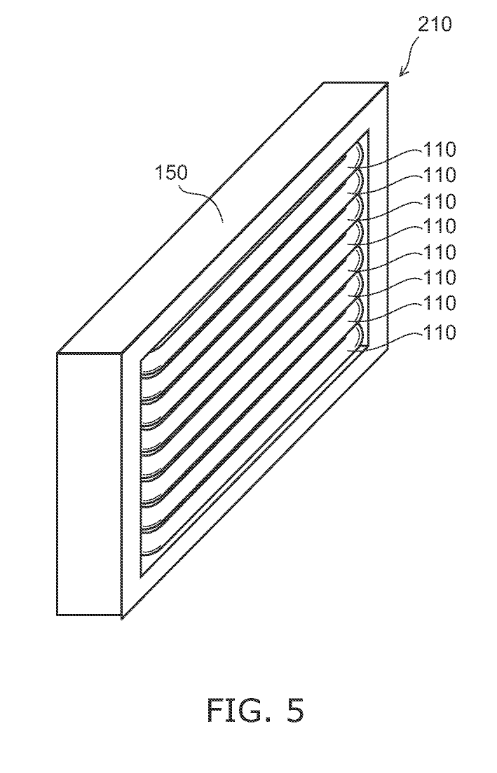

FIG. 5 is a schematic view illustrating the heating module according to a second embodiment.

As shown in FIG. 5, a heating module 210 according to the embodiment includes the heater lamp 110. In the example, a plurality of heater lamps 110 are provided. A holding portion 150 is further provided in the heating module 210. The holding portion 150 holds the heater lamps 110.

According to the heating module 210 of the embodiment, a heating module with a long lasting lifetime can be provided.

According to the embodiment, a heater lamp and a heating module which have a long lasting lifetime can be provided.

In the specification, the terms “perpendicular” and “parallel” include not only the strictly perpendicular and strictly parallel state but also include, for example, fluctuations and the like in manufacturing, thereby allowing the substantially perpendicular and substantially parallel state.

Hereinbefore, the exemplary embodiments are described referring to the specific examples without being limited thereto. For example, a specific configuration of each element such as the bulb, the filament, the conductive portion, and the outer lead included in the heater lamp; the holding portion included in the heating module; and the like are included within the scope of the exemplary embodiments, as long as those skilled in the art similarly carry out the exemplary embodiments by appropriately selecting from the known scope to obtain a similar effect.

Any combination of two or more elements of each specific example within a technically possible range is included within the scope of the exemplary embodiments, as long as including the spirit of the exemplary embodiments.

Otherwise, all the heater lamps that can be realized through appropriate design changing by those skilled in the art based on the above-described heater lamps as the exemplary embodiments belong to the scope of the exemplary embodiments, as long as including the spirit of the exemplary embodiments.

Otherwise, in the range of an idea, those skilled in the art can easily conceive at various modification examples and correction examples. Therefore, the aforementioned various modification examples and correction examples are understood to belong to the scope of the exemplary embodiments.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A heater lamp comprising:
a bulb being light transmissive, the bulb having a linear portion and at least one bent portion, the bulb being sealed at both ends of the bulb, the bulb having a filament provided inside the bulb, the filament including a plurality of first coils connected in series, and a second coil connected to the plurality of first coils in series, the second coil having a number of turns less than a number of turns of the first coils; and
an anchor ring holding the filament inside the bulb.

2. The heater lamp according to claim 1, wherein the second coil is provided in the bent portion.

3. The heater lamp according to claim 1, wherein the first coil includes a first light-emitting portion and a second light-emitting portion, and
the second light-emitting portion is provided in at least one of both ends of the bulb.

4. The heater lamp according to claim 3, wherein a number of turns of the second light-emitting portion is less than a number of turns of the first light-emitting portion, and more than a number of turns of the second coil.

5. The heater lamp according to claim 1, wherein the second coil includes at least one anchor ring.

6. The heater lamp according to claim 1, wherein both ends of the second coil include the first coil.

7. The heater lamp according to claim 1, wherein the number of turns of the second coil is ten turns or less.

8. The heater lamp according to claim 1, wherein when electric current flows through the filament, a temperature of the second coil is lower than a temperature of the first coil.

9. The heater lamp according to claim 1, wherein when electric current flows through the filament, an intensity of light emitted from the second coil is lower than an intensity of light emitted from the first coil.

10. The heater lamp according to claim 1, further comprising gas provided inside the bulb,
the gas including at least one of Ar, Kr and Xe, and at least one of nitrogen and bromine.

11. A heating module comprising:
a heater lamp including:
a bulb being light transmissive, the bulb having a linear portion and at least one bent portion, the bulb being sealed at both ends of the bulb, the bulb having a filament provided inside the bulb, the filament including a plurality of first coils connected in series, and a second coil connected to the plurality of first coils in series, the second coil having a number of turns less than a number of turns of the first coils; and
an anchor ring holding the filament inside the bulb.

12. The module according to claim 11, wherein the second coil is provided in the bent portion.

13. The module according to claim 11, wherein the first coil includes a first light-emitting portion and a second light-emitting portion, and
the second light-emitting portion is provided in at least one of both ends of the bulb.

14. The module according to claim 13, wherein a number of turns of the second light-emitting portion is less than a number of turns of the first light-emitting portion, and more than a number of turns of the second coil.

15. The module according to claim 11, wherein the second coil includes at least one anchor ring.

16. The module according to claim 11, wherein both ends of the second coil include the first coil.

17. The module according to claim 11, wherein the number of turns of the second coil is ten turns or less.

18. The module according to claim 11, wherein when electric current flows through the filament, a temperature of the second coil is lower than a temperature of the first coil.

19. The module according to claim 11, wherein when electric current flows through the filament, an intensity of light emitted from the second coil is lower than an intensity of light emitted from the first coil.

20. The module according to claim 11, further comprising gas provided inside the bulb,
the gas including at least one of Ar, Kr and Xe, and at least one of nitrogen and bromine.
